(19) United States
(12) Patent Application Publication
(10) Pub. No.: US 2014/0055573 A1
(43) Pub. Date: Feb. 27, 2014

(54) DEVICE AND METHOD FOR DETECTING A THREE-DIMENSIONAL OBJECT USING A PLURALITY OF CAMERAS

(71) Applicants: Jun-Seok Lee, Gyeongsangbuk-do (KR); Byung-Chan Jeon, Gyeongsangbuk-do (KR); Jong-Bin Yim, Gyeongsangbuk-do (KR)

(72) Inventors: Jun-Seok Lee, Gyeongsangbuk-do (KR); Byung-Chan Jeon, Gyeongsangbuk-do (KR); Jong-Bin Yim, Gyeongsangbuk-do (KR)

(73) Assignee: ETU SYSTEM, LTD., Gyeonsangbuk-do (KR)

(21) Appl. No.: 14/114,309

(22) PCT Filed: Apr. 29, 2011
(86) PCT No.: PCT/KR11/03242

§ 371 Date: Oct. 28, 2013

(30) Foreign Application Priority Data
Apr. 28, 2011 (KR) 10-2011-0040330

(51) Int. Cl. G06K 9/00; H04N 13/02

(52) U.S. Cl. CPC G06K 9/00201; H04N 13/0239
USPC 348/47

(57) ABSTRACT

The present invention relates to a device and method for detecting a three-dimensional object using a plurality of cameras that are capable of simply detecting a three-dimensional object. The device comprises: a planarization unit for planarizing, through homography conversion, each input image obtained by the plurality of cameras; a comparison-area selecting unit for selecting each area to be compared after adjusting the offset of a camera in order to overlay a plurality of images which have been planarized by said planarization unit; a comparison-processing unit for determining whether or not corresponding pixels are identical in the comparison area selected by said comparison-area selecting unit, and generating a single image based on the results of the determination; and an object-detecting unit for detecting a three-dimensional object disposed on the ground by analyzing the form of the single image generated by said comparison-processing unit.

### TECHNICAL FIELD

The present invention relates, in general, to the detection of an object using multiple cameras and, more particularly, to a device and method for detecting a three-dimensional (3D) object using multiple cameras, which can simply detect a 3D object using multiple cameras.

### BACKGROUND ART

Cameras may be regarded as devices for mapping a three-dimensional (3D) space to a two-dimensional (2D) plane (image plane). That is, projection from 3D onto 2D is performed, wherein 3D information is lost. Therefore, it is impossible to detect a location in a 3D space using only a single 2D image. If there are two images and all cameras are calibrated, it is possible to obtain 3D information. This may be theoretically illustrated, as shown in FIG. 1.

In FIG. 1, (u,v) denotes image coordinates and (x,y,z) denotes 3D coordinates. P=(x,y,z) is a 3D point, P_{L}=(u_{L}, v_{L})^{T} and P_{R}=(u_{R}, v_{R})^{T} denote corresponding points on a left camera and a right camera,

$${O}_{L} = ( - \frac{{B}_{x}}{2} , 0 , 0 )$$

and

$${O}_{R} = ( \frac{{B}_{x}}{2} , 0 , 0 )$$

denote the centers of the respective cameras, bₓ denotes a distance between the two cameras (baseline distance), and f denotes a focal length. Here, the two cameras are assumed to be identical.

In this case, image coordinates may be represented by 3D coordinates, as given by the following Equation 1:

$$[ \begin{matrix}{u}_{L} \\ {v}_{L}\end{matrix} ] = \frac{f}{z} [ \begin{matrix}x - ( - {b}_{x} / 2 ) \\ y\end{matrix} ] = \frac{f}{z} [ \begin{matrix}x + {b}_{x} / 2 \\ y\end{matrix} ] \\ [ \begin{matrix}{u}_{R} \\ {v}_{R}\end{matrix} ] = \frac{f}{z} [ \begin{matrix}x - ( - {b}_{x} / 2 ) \\ y\end{matrix} ] \\ {u}_{L} - {v}_{L} = \frac{f}{z} {b}_{x} \text{:} disparity \qquad Equation 1$$

Therefore, when there are two images and corresponding points thereof are known, 3D coordinates corresponding to the points can be obtained by the following Equation (2):

$$[ \begin{matrix}x \\ y\end{matrix} ] = \frac{z}{f} [ \begin{matrix}{u}_{L} \\ {v}_{L}\end{matrix} ] - [ \begin{matrix}{b}_{x} / 2 \\ 0\end{matrix} ] = \frac{z}{f} [ \begin{matrix}{u}_{R} \\ {v}_{R}\end{matrix} ] + [ \begin{matrix}{b}_{x} / 2 \\ 0\end{matrix} ] \\ z = \frac{{fb}_{x}}{{u}_{L} - {u}_{R}} \qquad Equation 2$$

However, since measurement error actually exists, V_{L} ≠ V_{R} is satisfied. The optical axes of two cameras may not be parallel with each other, and the focal lengths of the two cameras may be different from each other. Further, since the sizes of image pixels are not 0, two lines (rays) may not intersect each other in a 3D space upon back projection.

Further, since matching points on images must be obtained (for example, a corner detector, Scale-Invariant Feature Transform (SIFT)/Speeded Up Robust Features (SURF) for sparse point, dense matching (with correlation)), a computational load required to extract a 3D objet is increased.

In order to reduce the burden of matching, image rectification using epipolar constraint may be used, as shown in FIG. 2. In this case, the problem of 2D matching may be simplified into 1D matching.

However, in order to obtain an in-depth map, matching points for all points in images must be obtained, and thus calculation cost is still high. Furthermore, when a distance between two cameras is short, error may increase if a 3D point is located far away from the cameras.

Meanwhile, 3D reconstruction is a method of detecting the coordinates of a 3D point in images acquired by any two or more cameras. A stereo camera may be regarded as being included in methods which use 3D reconstruction in that the locations of cameras may be arbitrarily set. However, in the case of 3D reconstruction, all normal cases can be processed, and thus 3D reconstruction is theoretically complicated in proportion to such processing, and calculation cost is also high.

In order to perform 3D reconstruction, corresponding points in respective images must be first detected, as shown in FIG. 3. In this case, a corner detector may be implemented using a feature detector, such as an SIFT or SURF detector. Matching points obtained in this way are used to search for a fundamental matrix (f matrix). The fundamental matrix represents a relationship between two points in epipolar geometry.

In this case, x=(x,y,z)^{T} and x′=(x′, y′, l) denote a corresponding pair in images, and FF denotes a fundamental matrix.

If multiple corresponding pairs can be obtained, the fundamental matrix may be obtained based on the corresponding pairs. The fundamental matrix may be obtained via Singular Value Decomposition (SVD). Further, when feature points correspond to each other, outliers may be present, and thus the outliers may be eliminated using a method such as RANdom SAmple Consensus (RANSAC) and a more precise fundamental matrix may be obtained.

If the fundamental matrix is obtained, a projection matrix (3D to 2D) for the cameras may be obtained. If projection matrixes obtained when three images are given are assumed to be P, P′, and P″, a 3D point x and points in the respective images, that is, x=(x, y, l)^{T}, x′=(x′, y′, l)^{T}, and x″=(x″, y″, l)^{T}, have a relationship given by the following Equation 3:

$$x = PX = [ \begin{matrix}{p}^{1 T} \\ {p}^{2 T} \\ {p}^{3 T}\end{matrix} ] X , \\ {x}^{′} = PX = [ \begin{matrix}{p}^{′ 1 T} \\ {p}^{′ 2 T} \\ {p}^{′ 3 T}\end{matrix} ] X , \\ {x}^{″} = PX = [ \begin{matrix}{p}^{″ 1 T} \\ {p}^{″ 2 T} \\ {p}^{″ 3 T}\end{matrix} ] X \qquad Equation 3$$

Therefore, a linear equation given by the following Equation 4 may be obtained from a single corresponding pair, and x may be obtained using SVD.

$$[ \begin{matrix}{xp}^{3 T} - {p}^{1 T} \\ {yp}^{3 T} - {p}^{2 T} \\ {x}^{′} {p}^{′3 T} - {p}^{′1 T} \\ {y}^{′} {p}^{′3 T} - {p}^{′2T} \\ {xp}^{″3 T} - {p}^{″1 T} \\ {yp}^{″3 T} - {p}^{″ 2 T}\end{matrix} ] X = 0 \qquad Equation 4$$

In this case, the obtained reconfiguration x corresponds to projection reconfiguration, which has a homographic relation to an actual coordinate point Xₘ in a 3D space and has ambiguity.

P_{M}ⁱ=PⁱH and X_{M}=H⁻¹X are satisfied, where HH may be obtained if camera parameters are given. Alternatively, HH may be obtained using auto-calibration.

As described above, in the past, a computational load and time required to extract a 3D object using two images are increased, and thus it is not easy to apply a 3D object extraction method to fields requiring real-time calculation.

### DISCLOSURE

### Technical Problem

The present invention is intended to provide a device and method for detecting a 3D object using multiple cameras, which can simply detect a 3D object using homographic images acquired by multiple cameras.

Technical objects of the present invention are not limited to the above-described objects.

### Technical Solution

A device for detecting a three-dimensional (3D) object using multiple cameras to accomplish the above object includes a planarization unit for individually planarizing input images acquired by multiple cameras via homography transformation; a comparison region selection unit for calibrating offset of the cameras so that multiple images planarized by the planarization unit are superimposed on each other, and individually selecting regions to be compared; a comparison processing unit for determining whether corresponding pixels in the comparison regions selected by the comparison region selection unit are identical to each other, and generating a single image based on results of the determination; and an object detection unit for analyzing a shape of the single image generated by the comparison processing unit and detecting a 3D object located on a ground.

The comparison processing unit may subtract pieces of data of the corresponding pixels from each other, determine that two pixels are different from each other if an absolute value of a difference obtained from the subtraction is equal to or greater than a preset reference value, and determine that the two pixels are identical to each other if the absolute value is less than the preset reference value.

The object detection unit may determine whether a 3D object is present, based on the intensity distribution of gray levels of a single image appearing when radially scanning the single image based on the respective locations of the multiple cameras, and may acquire information about a location and a height of a 3D object only if a 3D object is present.

A method of detecting a three-dimensional (3D) object using multiple cameras to accomplish the above object includes individually planarizing input images acquired by multiple cameras via homography transformation; calibrating offset of the cameras so that planarized multiple images are superimposed on each other, and individually selecting regions to be compared; determining whether corresponding pixels in the selected regions are identical to each other, and generating a single image based on results of the determination; and analyzing a shape of the single image and detecting information about presence/non-presence, location, and height of a 3D object located on a ground.

Generating the single image may include subtracting pieces of data of corresponding pixels in the selected regions from each other; comparing an absolute value of a difference obtained from the subtraction with a preset reference value; if the absolute value is equal to or greater than the reference value, determining that the two pixels are different from each other, whereas if the absolute value is less than the reference value, determining that the two pixels are identical to each other; and generating a single image having a plurality of gray levels based on results of the determination.

Detecting the object may include detecting the intensity distribution of gray levels of a single image by radially scanning the single image based on the respective locations of the multiple cameras; and determining whether a 3D objet is present, based on the intensity distribution of gray levels and information about coordinates of each pixel of the image, and acquiring information about one or more of a location and a height of a 3D object if the 3D object is present.

### Advantageous Effects

As described above, the present invention can simply detect information about the presence/non-presence, location, and height of a 3D object, based on homographic images acquired by multiple cameras, so that a computational load required to extract the 3D object is low and fast calculation is possible, unlike conventional methods, thus enabling the present invention to be utilized for effectively detecting distances to an object (an obstacle), a pedestrian, etc. in robots, vehicles, etc. which require real-time calculation.

### DESCRIPTION OF DRAWINGS

FIGS. 1 to 3 are diagrams showing a 3D configuration method using multiple images;

FIG. 4 is a diagram showing a device for detecting a 3D object using multiple cameras according to the present invention;

FIG. 5 is a flowchart showing a process for detecting a 3D object according to an embodiment of the present invention;

FIG. 6 is a diagram showing respective images captured by multiple cameras;

FIG. 7 is a diagram showing homography transformation performed on the images of FIG. 6;

FIGS. 8 and 9 are diagrams showing images obtained by calibrating camera offset on the individual images of FIG. 7 and combining calibrated images; and

FIGS. 10 to 14 are diagrams showing a process for detecting a 3D object from the image of FIG. 9.

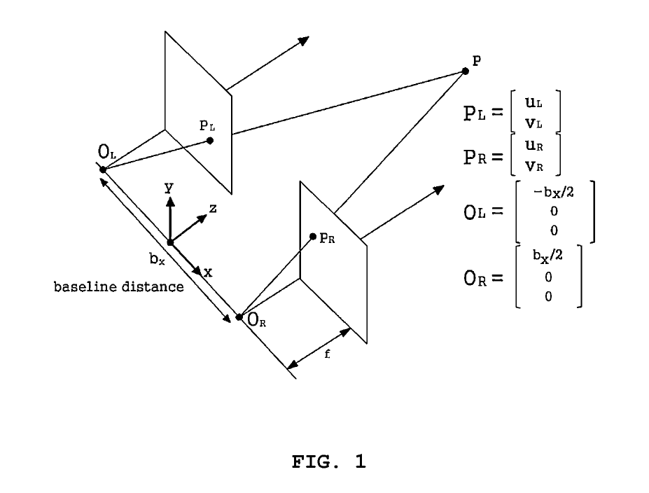

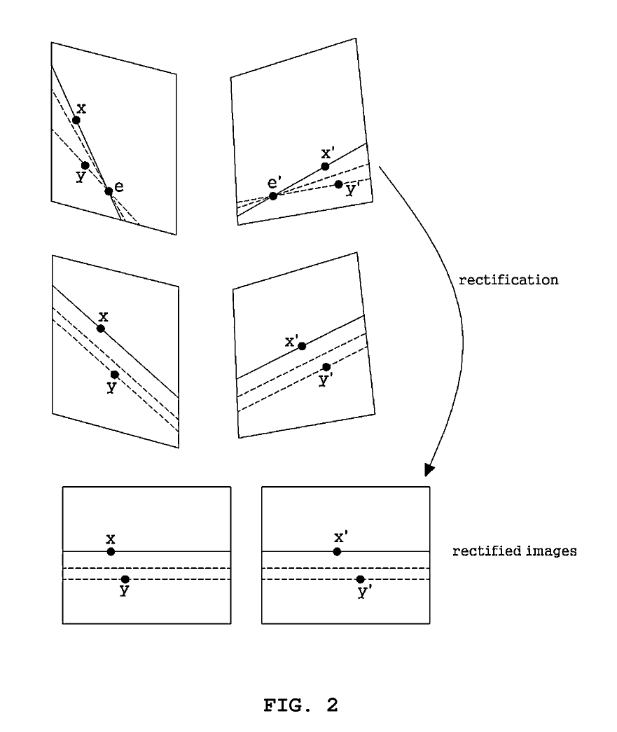

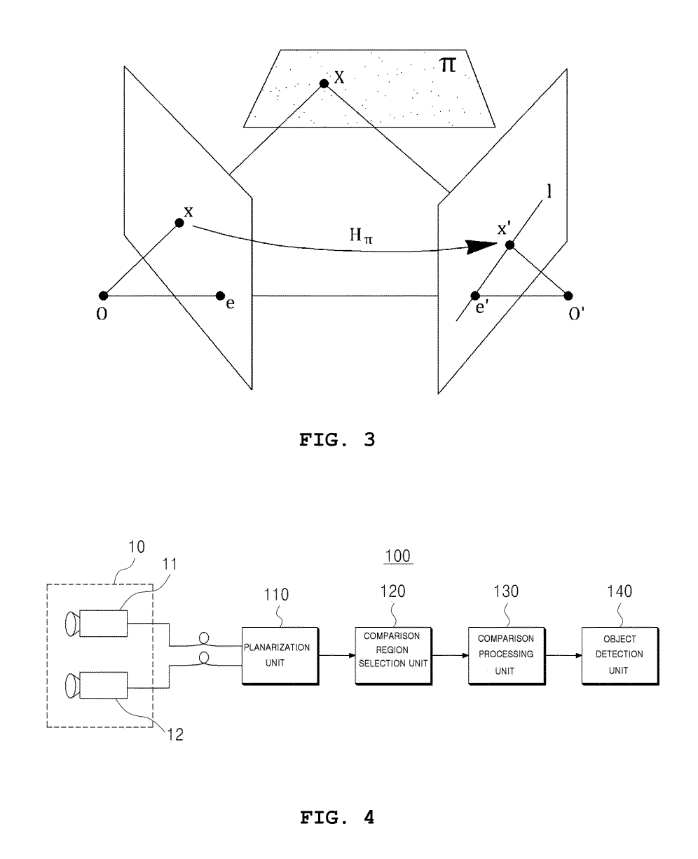

### BEST MODE

Hereinafter, preferred embodiments of the present invention will be described in detail with reference to the attached drawings. The same reference numerals are used throughout the different drawings to designate the same components if possible. Further, detailed descriptions of known functions and elements that may unnecessarily make the gist of the present invention obscure will be omitted.

FIG. 4 is a diagram showing a device for detecting a 3D object using multiple cameras according to the present invention, wherein a detection device 100 is configured to include a planarization unit 110, a comparison region selection unit 120, a comparison processing unit 130, and an object detection unit 140.

The planarization unit 110 planarizes respective input images acquired by multiple cameras 10 (11 and 12) via homography transformation. The multiple cameras 10 are installed to be spaced apart from each other at regular intervals, and may be implemented as a first camera 11 and a second camera 12 having an overlapping region. Here, homography transformation uses known technology, and thus a detailed description thereof will be omitted.

The comparison region selection unit 120 calibrates the offset of the cameras so that multiple images planarized by the planarization unit 110 can be superimposed on each other, and thereafter individually selects regions to be compared. Here, it is preferable to select only effective regions with the exclusion of ineffective regions, depending on locations at which the individual cameras 11 and 12 are placed.

The comparison processing unit 130 determines whether corresponding pixels are identical to each other in the comparison regions selected by the comparison region selection unit 120, and generates a single image having a plurality of gray levels based on the results of the determination. In this case, the comparison processing unit 130 performs subtraction between pieces of data of respective corresponding pixels, and determines that two pixels are different from each other if the absolute value of a difference obtained from subtraction is equal to or greater than a preset reference value, whereas it determines that the two pixels are identical to each other if the absolute value is less than the preset reference value. Further, the comparison processing unit 130 uses each pixel to be compared and its neighboring pixels together and may also determine whether pixels are identical to each other using the average value of a plurality of pixels so as to obtain more exact results.

The object detection unit 140 analyzes the shape of the single image generated by the comparison processing unit 130 and detects a 3D object located on the ground. Here, the object detection unit 140 may detect information about the presence/non-presence, location, and height of a 3D object, using the intensity distribution of individual pixels of the single image and information about the relative locations of each pixel from the cameras. For example, the object detection unit 140 may detect the intensity distribution of gray levels of the single image by radially scanning the single image based on the respective locations of the multiple cameras, and acquire information about a 3D object using the detected intensity distribution and the relative coordinates of each pixel to the cameras.

In this way, the present invention may process homography on the images acquired by the multiple cameras 10 and may detect information about whether a 3D object is present, the location (x, y coordinates) of the 3D object in a plane, and the height of the 3D object.

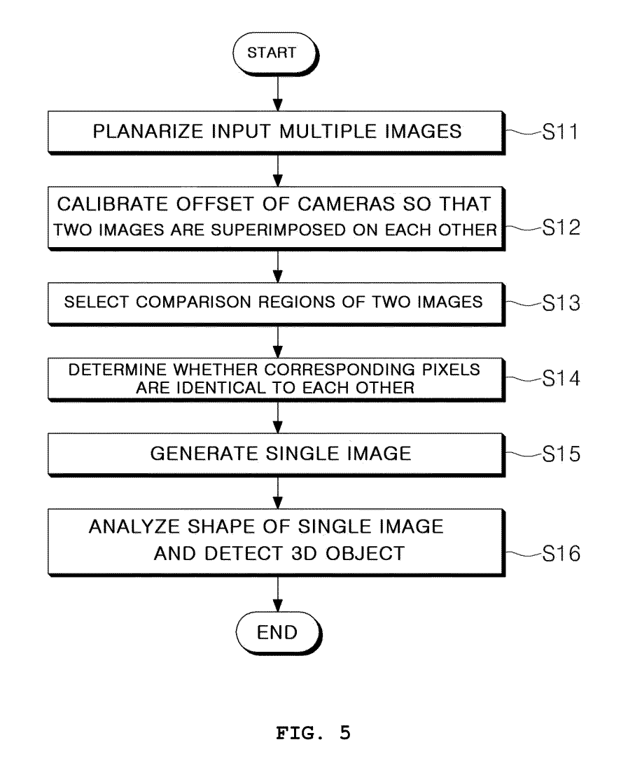

The process of operating the 3D object detection device configured in this way will be described in detail with reference to the flowchart of FIG. 5 and other attached drawings.

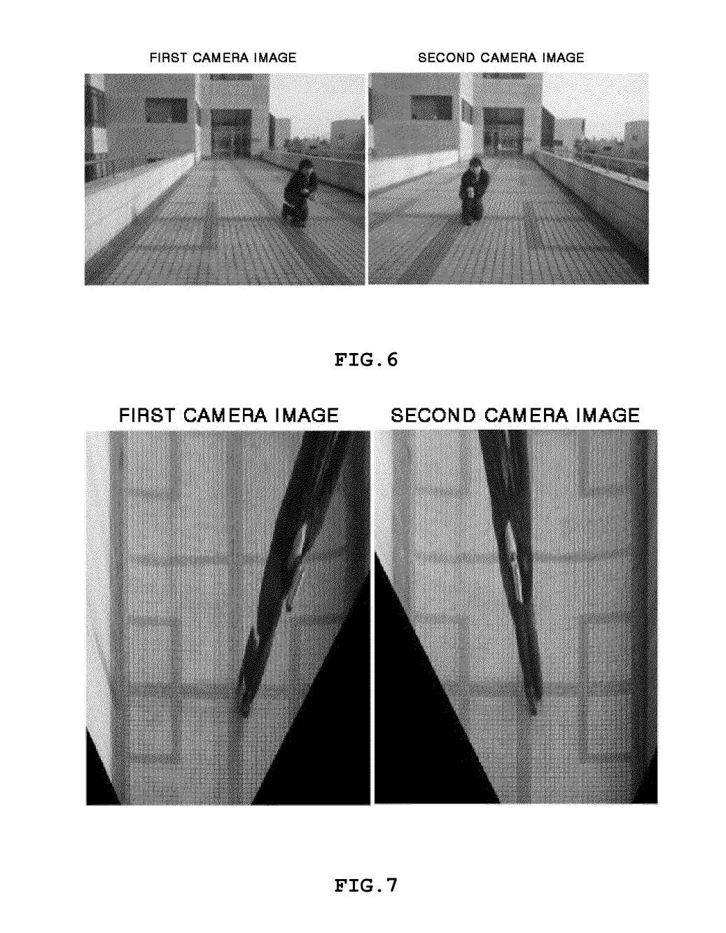

As shown in FIG. 5, the planarization unit 110 planarizes respective input images, such as those shown in FIG. 6, acquired by the multiple cameras 10, through homography transformation, as shown in FIG. 7 (S11). Here, the homography process is a process for transforming each image facing the corresponding camera into an image vertically looked down from above, as if the camera had captured an image of a target object from above. In FIG. 7, both lower edge portions (black portions) are regions which overlap each other due to the multiple cameras and which are not actually viewed, and denote regions ineffective in comparison even after planarization and offset processing have been completed.

Since the input images used for planarization correspond to images captured at different viewpoints for respective cameras 11 and 12, a process for transforming those images into images at a single viewpoint, that is, a viewpoint at which images are vertically looked down from above, is the homography process. An image generated by performing the homography process is a homographic image.

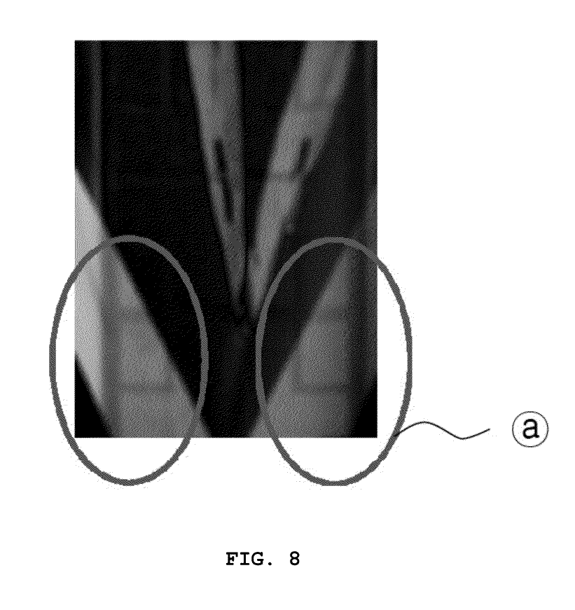

Then, the comparison region selection unit 120 calibrates the offset of the respective cameras 11 and 12 so that multiple homographic images are superimposed on each other (S12), and individually selects regions to be compared (S13). That is, when images of the same planar region are captured by two different cameras 11 and 12, the comparison region selection unit 120 causes the respective images captured by the cameras 11 and 12 to be superimposed on each other if the offset of the cameras is calibrated. However, in the case of homography performed in the presence of a 3D object, since directions faced by the two cameras 11 and 12 are different from each other, two homographic images do not exactly overlap each other, as shown in FIG. 8, even if the offset is calibrated.

Before homographic images acquired by the two cameras are compared with each other, a Region Of Interest (ROI) setting procedure for excluding ineffective region (\textcircled{a}) depending on the locations at which the cameras are placed is performed. Such ineffective regions (\textcircled{a}) are regions which are not identical to each other even if the offset of the cameras is calibrated, and are excluded so that the corresponding object is not falsely recognized as a 3D object in a subsequent procedure for comparing two homographic images.

In this way, if the offset of the cameras has been calibrated and ROI setting has been completed, the comparison processing unit 130 compares the two homographic images, such as those shown in FIG. 7, with each other, and determines whether the coordinates of the corresponding pixels in the two images are identical to each other or different from each other (S14). That is, it is determined whether the corresponding pixels in the above selected regions are identical to each other, and generates a single image based on the results of the determination. Here, the method of determining whether pixels are identical to each other may be configured such that the absolute value of a difference obtained from the subtraction between pieces of data of respective pixels, such as saturation or brightness data, is normalized using a maximum value or a mean value, and such that if the absolute value of a difference obtained when two normalized pixel values are subtracted from each other is equal to or greater than 0.5, it is determined that the two pixels are different from each other, whereas if the absolute value is less than 0.5, it is determined that the pixels are identical to each other. However, in order to reduce the occurrence of error, a scheme for utilizing pieces of information about not only the corresponding one target pixel but also neighboring pixels around the target pixel, and for comparing pixels using the mean value of a plurality of pixels may also be used. In addition, the method of determining whether corresponding pixels are identical to each other may be modeled by various mathematical modeling means.

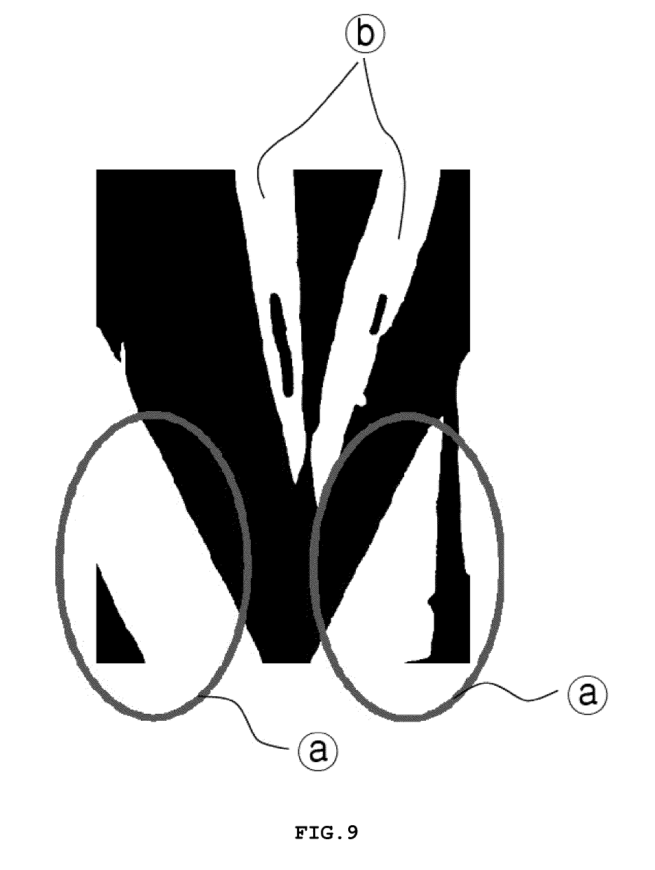

After it has been determined whether pixels are identical to each other and a single image has been generated based on the results of the determination, if thresholds are filtered, a single image in which contrast clearly appears may be obtained, as shown in FIG. 9, depending on whether the pixels are identical (S15). FIG. 9 shows that different points between corresponding pixels from the multiple cameras 10 are expressed in white and identical points are expressed in black. In this case, it can be seen that a portion \textcircled{b} in which a 3D object is present is shown in white as being divided into two branches from the center of FIG. 9. Since a person corresponding to the 3D object is projected in different directions by different cameras 11 and 12, images thereof do not exactly overlap each other and are represented by two different white clusters \textcircled{b}, as shown in FIG. 9, even if the images are planarized and the offset of the cameras is calibrated. In this case, circular portions \textcircled{a} indicated in the lower portion of FIG. 9 are regions excluded by the setting of an ROI. Therefore, even if portions \textcircled{a} are expressed in white, they are not caused by the presence of a 3D object and are meaningless regions.

As described above, after it has been determined whether corresponding pixels in the multiple images are identical to each other and the single image has been generated, the object detection unit 140 analyzes the shape of the single image and acquires information about the 3D object (the presence/non-presence, location, and height of the 3D object) (S16).

Such a procedure S16 for detecting the 3D object will be described in detail below. That is, in FIG. 9, it can be seen that characteristics appearing when a 3D object located on the ground is planarized exhibit that white-colored regions are extended long in directions toward the object from the locations of the respective cameras. By using these attributes, information about the presence/non-presence of a 3D object and the location and height of a 3D object when the 3D object is present may be detected.

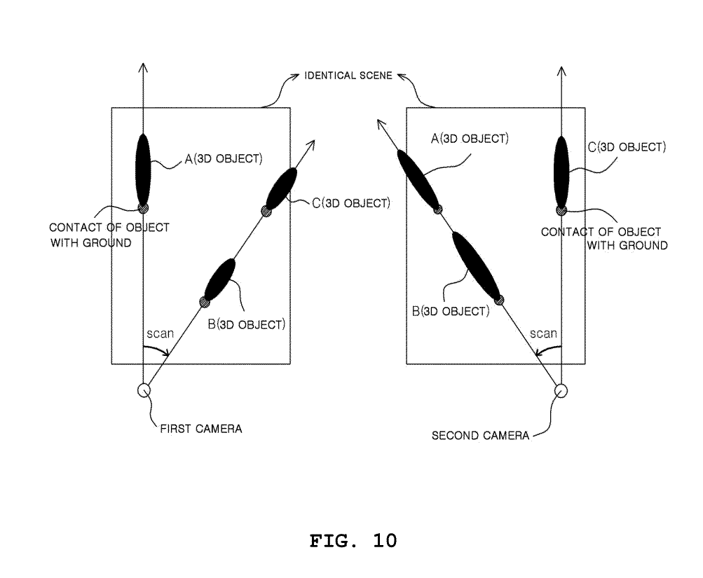

For example, as shown in FIG. 10, if radial lines are drawn from the locations of the respective cameras 11 and 12 to the surrounding area of each object in homographic images, it can be seen that when the direction of a line is identical to that of the major axis of a black-colored region in which a ground object (a 3D object) is planarized, a portion expressed in black is shown as being the longest area. When homography is performed on the same place where three 3D objects A, B, and C are present, the images of FIG. 10 are represented for the respective cameras 11 and 12. In this case, a scheme for scanning a homographic ROI while gradually changing an angle using virtual light around the locations of the respective cameras 11 and 12 as center points is designated as radial scanning.

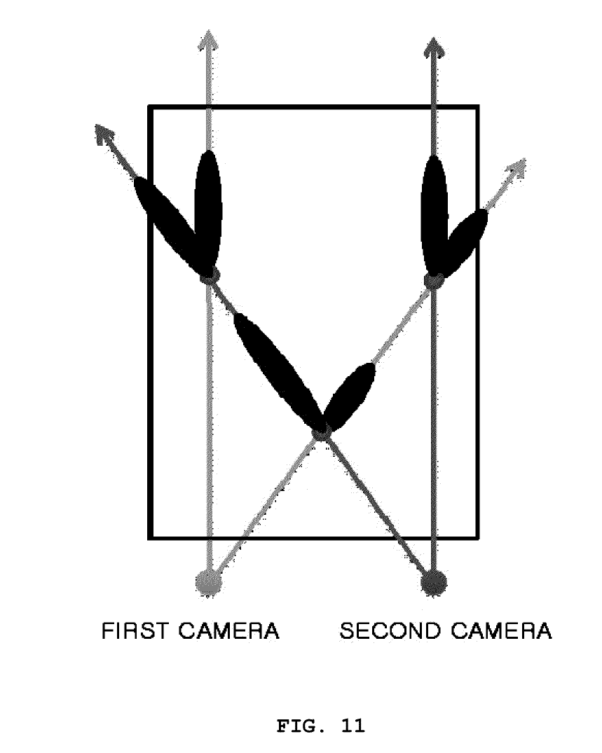

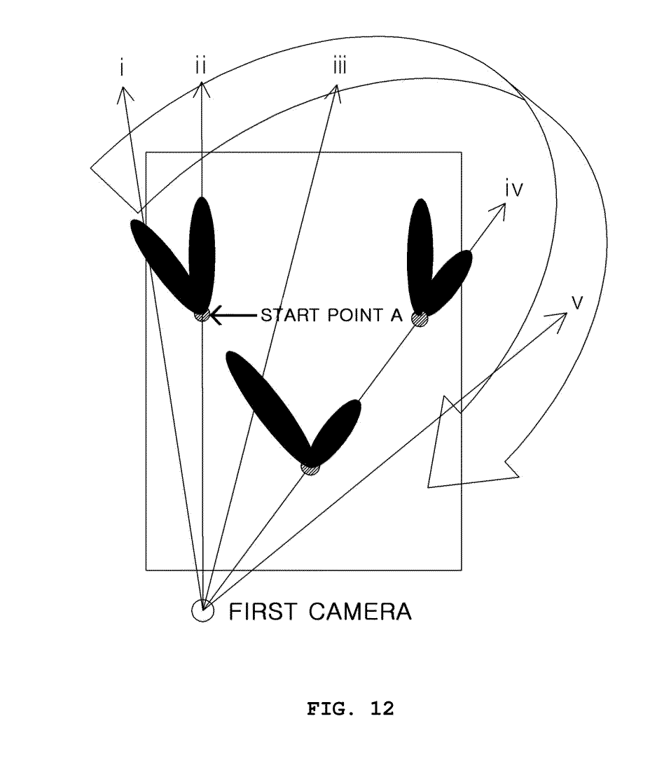

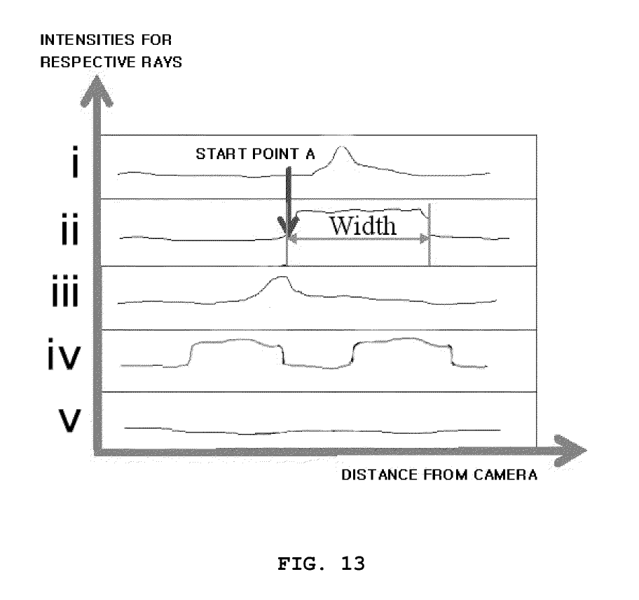

In this way, when homographic images acquired by the first camera 11 and the second camera 12 are combined into a single image, an image of FIG. 11 is obtained. If the image combined in this way is radially scanned around the location of the first camera 11, as shown in FIG. 12, the distribution of intensities for respective radial rays may be known, as shown in FIG. 13.

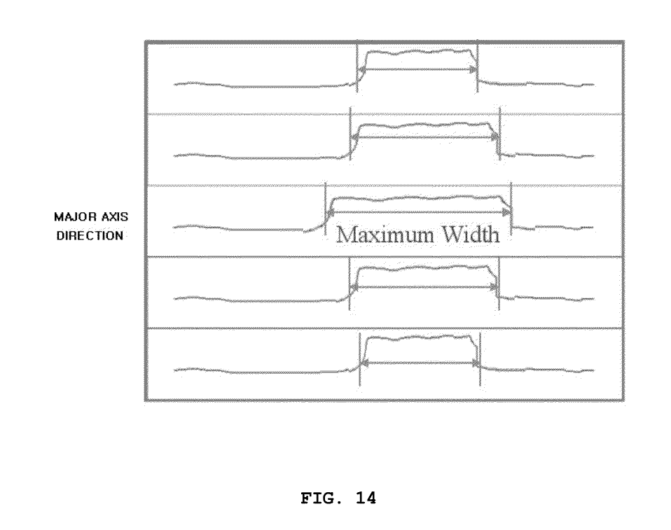

As shown in FIG. 13, in the case of second scan (ii) and fourth scan (iv), it can be seen that a portion having large intensity appears by a predetermined width or more. Since the object detection unit 140 knows a start point and an angle, linear equations of second scan (ii) and fourth scan (iv) can be obtained. Further, since the direction of an axis and a distance from the corresponding camera can be known, the coordinates (x,y) of start point A which is a point at which intensity becomes strong in FIG. 12 can be detected. The radial rays before and after the major axes of the 3D object show characteristics that the width of an interval having strong intensity is gradually widened before the direction of the exact major axis and is then gradually narrowed after the direction of the major axis, as shown in FIG. 14.

If scanning is performed based on the second camera 12 in the same manner as that of FIG. 12, an effective linear equation and the location of a start point may be found. That is, after an intersection of effective radial rays selected by the first camera 11 and the second camera 12 has been obtained, points having the same start points (within an error range), which have been found by the first camera 11 and the second camera 12, are obtained.

However, such a method is only one method for finding a start point from the combination of planarized (homographic) images, and other methods may also be used if necessary. It is important that, rather than obtaining a method of finding the location of a start point from a combined homographic pattern, information about whether a 3D object is present and information about one or more of the location and height of a 3D object in the presence of the 3D object may be easily detected from a combined homographic image of the 3D object acquired using two cameras due to the characteristics of homography transformation of a 3D object. The height information of the 3D object is additional information, and an exact height can be calculated only when the entire region of the object falls within an ROI. If the extended region \textcircled{b} shown in FIG. 9 does not fall within the ROI, only information indicating that the object has a height equal to or greater than a predetermined height can be obtained.

Such a 3D object detection system can be utilized in vehicle safety systems or the like which require real-time detection of whether a pedestrian and an obstacle are present, and the location information of the 3D object.

The above-described 3D object detection method is not limited by the configuration and operation scheme of the above-described embodiments. The embodiments may be configured such that some or all of the embodiments are selectively combined to make various modifications.

What is claimed is:

1. A device for detecting a three-dimensional (3D) object using multiple cameras, comprising:
a planarization unit for individually planarizing input images acquired by multiple cameras via homography transformation;
a comparison region selection unit for calibrating offset of the cameras so that multiple images planarized by the planarization unit are superimposed on each other, and individually selecting regions to be compared;
a comparison processing unit for determining whether corresponding pixels in the comparison regions selected by the comparison region selection unit are identical to each other, and generating a single image based on results of the determination; and
an object detection unit for analyzing a shape of the single image generated by the comparison processing unit and detecting a 3D object located on a ground.

2. The device of claim 1, wherein the comparison processing unit subtracts pieces of data of the corresponding pixels from each other, determines that two pixels are different from each other if an absolute value of a difference obtained from the subtraction is equal to or greater than a preset reference value, and determines that the two pixels are identical to each other if the absolute value is less than the preset reference value.

3. The device of claim 1, wherein the comparison processing unit determines whether the corresponding pixels are identical to each other, by using data about each pixel to be compared and neighboring pixels thereof together.

4. The device of claim 1, wherein the object detection unit detects an intensity distribution of gray levels of the single image by radially scanning the single image based on respective locations of the multiple cameras, and acquires one or more of presence/non-presence, location and height of a 3D object, using the detected intensity distribution and information about relative coordinates of each pixel to the cameras.

5. A method of detecting a three-dimensional (3D) object using multiple cameras, comprising:
individually planarizing input images acquired by multiple cameras via homography transformation;
calibrating offset of the cameras so that planarized multiple images are superimposed on each other, and individually selecting regions to be compared;
determining whether corresponding pixels in the selected regions are identical to each other, and generating a single image based on results of the determination; and
analyzing a shape of the single image and detecting a 3D object located on a ground.

6. The method of claim 5, wherein selecting the regions to be compared is configured to select only effective regions depending on locations at which the respective cameras are placed.

7. The method of claim 5, wherein generating the single image comprises:
subtracting pieces of data of corresponding pixels in the selected regions from each other;
comparing an absolute value of a difference obtained from the subtraction with a preset reference value;
if the absolute value is equal to or greater than the reference value, determining that the two pixels are different from each other, whereas if the absolute value is less than the reference value, determining that the two pixels are identical to each other; and
generating a single image having a plurality of gray levels based on results of the determination.

8. The method of claim 5, wherein generating the single image is configured to, upon determining identicalness of the pixels, determine whether the pixels are identical to each other by using data about each pixel to be compared and neighboring pixels thereof together.

9. The method of claim 5, wherein detecting the object comprises:
detecting an intensity distribution of gray levels of the single image by radially scanning the single image based on the respective locations of the multiple cameras; and
determining one or more of presence/non-presence, location, and height of a 3D object, using the intensity distribution of gray levels and coordinates of each pixel of the image.
